(19) United States
(12) Patent Application Publication
(10) Pub. No.: US 2010/0274591 A1
(43) Pub. Date: Oct. 28, 2010

(54) MEDICAL IMPLANT TRACKING AND ORDER MANAGEMENT

(75) Inventor: Ryan Wells, Nashville, TN (US)

Correspondence Address: HOGAN LOVELLS US LLP;IP GROUP, COLUMBIA SQUARE, 555 THIRTEENTH STREET, N.W., WASHINGTON, DC, 20004, US

(73) Assignee: Invivolink, Nashville, TN (US)

(21) Appl. No.: 12/767,558

(22) Filed: Apr. 26, 2010

Related U.S. Application Data
(60) Provisional application No. 61/172,552, filed on Apr. 24, 2009.

(51) Int. Cl. G06Q 50/00; G06N 5/02; G06Q 10/00

(52) U.S. Cl. 705/3; 706/54; 705/9

(57) ABSTRACT

An aspect of the present invention may allow medical equipment and/or implants tracking from time of ordering through distribution to the patient. A second aspect may provide a physician or user with the ability to pre-establish certain preferences for which implants to use with a particular type of patient utilizing factors such as activity level, age, and BMI. Another aspect of the present invention may relate to providing a module or interface for a nurse or user to schedule procedures. In some embodiments, a nurse can schedule the procedure by knowing only the physician performing the surgery, what anatomy group needs the surgery or implant, and one or two patient factors (age and activity level for example.) Another aspect of the present invention may relate to providing an analysis tool to allow users to determine clinical data or draw comparisons about the efficacy of certain procedures or implants.

### PRIORITY

This application claims the benefit of priority to U.S. provisional application 61/172,552 filed Apr. 24, 2009; the disclosure of which is incorporated by reference in its entirety.

### BACKGROUND OF THE INVENTION

Improving distribution, selection, and installation of implants in patients who need them is an ongoing problem throughout the world. Communication breakdown and the lack of an integrated software platform that can place and keep various players in the medical implant process in synch during scheduling, ordering, and deployment of the implant and/or medical equipment has led to incorrect implantations, missed scheduling of procedures, increased overhead and oversight by physicians, and host of other complications.

### SUMMARY OF THE INVENTION

To overcome these and other problems, one aspect of the present invention may allow medical equipment and/or implant to be tracked from time of ordering through distribution to the patient. A second aspect may provide a physician or user with the ability to pre-establish certain preferences for which implants to use with a particular type of patient utilizing factors such as activity level, age, and BMI. Another aspect of the present invention may relate to providing a module or interface for a nurse or user to schedule procedures. In some embodiments, a nurse can schedule the procedure by knowing only the physician performing the surgery, what anatomy group needs the surgery or implant, and one or two patient factors (age and activity level for example.) Another aspect of the present invention may relate to providing an analysis tool to allow users to determine clinical data or draw comparisons about the efficacy of certain procedures or implants.

### BRIEF DESCRIPTION OF THE FIGURES

FIG. 1 is a diagram of the software platform and its associated modules and users;

FIG. 2 is a representative image of the Schedule Module depicted in FIG. 1;

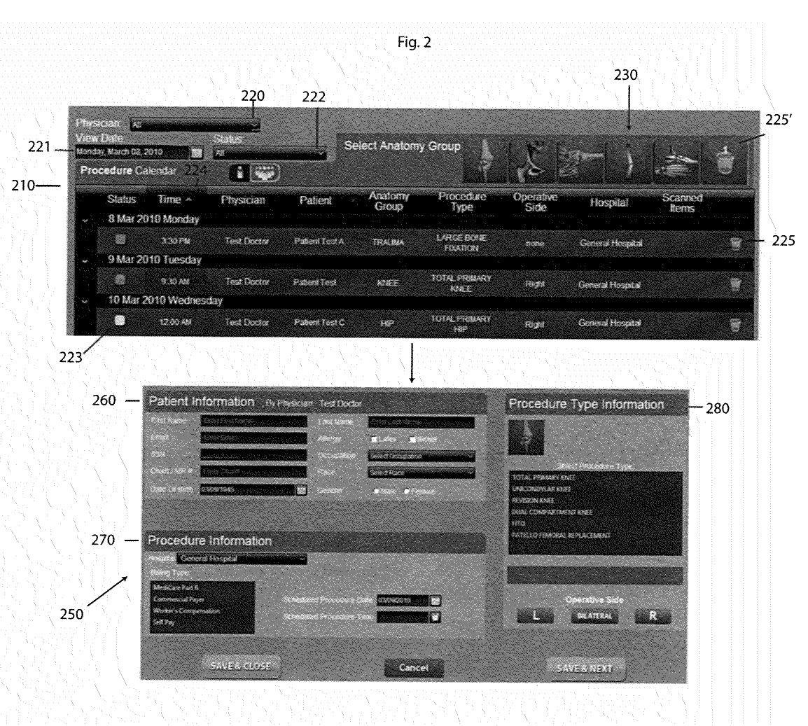

FIG. 3 is a representative illustration of the Orders Module depicted in FIG. 1;

FIG. 4 is a representative illustration of the Preference Module depicted in FIG. 1;

FIG. 5 is a representative illustration of the Warehouse Module depicted in FIG. 1;

FIG. 6 is a representative illustration of the Hospital Module depicted in FIG. 1; and

FIG. 7 is a representative illustration of the Patient Module depicted in FIG. 1.

### DETAILED DESCRIPTION OF THE INVENTION

One embodiment of the present invention relates to a software platform 10 for providing improved medical care and tools to users such as nurses 2, manufacturers 3, physicians 4, warehouses 5, hospital staff 6, and patients 7 (collectively users 1). In one embodiment of the present invention the software platform 10 may contain nine modules: the analysis module 100, the schedule module 200, the orders module 300, the recall module 350, the preferences module 400, the warehouse module 500, the hospital module 600, the control module 650, and the patient module 700. Although the application describes in certain embodiments that a specific user (e.g. a nurse 2) may use a specific module (e.g. the schedule module 200) the modules may be designed to allow other users 1 to use the specific module. Moreover, a specific user (e.g. a physician 4) may use more than one module (e.g. the preference module 400, and schedule module 200). Also, a given location (e.g. hospital, warehouse, etc) may have more than one module, and sometimes each room of the location may have its own module or a plurality of modules to allow multiple people to access the software platform 10 at the same time.

A module may be software stored on one or more client computers. The client computer may contain a microprocessor, a hard drive, and memory for executing software such as the software platform. The computer may also comprise a standard display (like a monitor), a scanner, magnetic card reader, RFID tag reader, barcode reader, and/or a touch screen display. The hard drive of the computer may contain a client version of the software platform. In some embodiments, the client version of the software platform may be executed in a web browser.

The software platform 10 and database 20 may be software stored in one or more servers (or executed via a decentralized server model). The software may be stored on computer readable media, such as hard drives, memory, CDs, DVDs, or flash drives. The software platform 10 may contain instructions for causing a processor of the one or more servers to execute certain commands such as storing information in the database 20, querying the database 20, deleting database entries, sending information to the modules or client computers, sending html code to the web browser of the client computer, receiving information from the modules or client computers, and analyzing information sent to or from the client computer or modules.

One of the goals of the software platform 10, in some embodiments, is the tracking of medical equipment such as implants (e.g. artificial hips and hip parts), disposables (e.g. sutures, sponges), and instrumentation (e.g. X-rays, EKGs). In certain configurations, the software platform can be used to facilitate booking of procedures such as surgeries, analyze effectiveness of equipment, facilitate ordering of equipment, and/or control inventory loss in hospitals. Although the following disclosure make use of titles to demark various portions of the specification, these titles are for navigational purposes only and should not be construed as limiting any aspects of the disclosure.

### The Preference Module 400

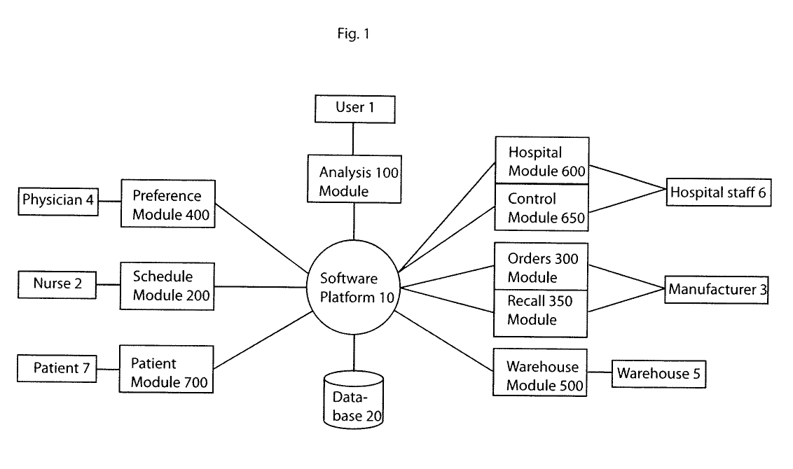

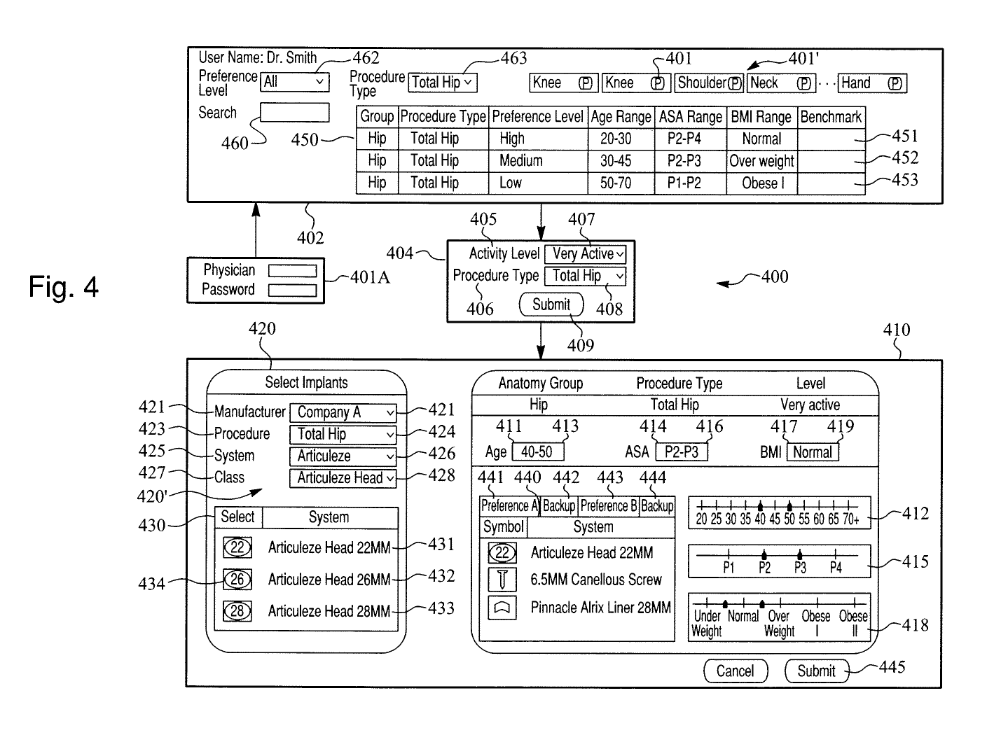

FIGS. 1 and 4 illustrate an embodiment of the preference module 400. In the configuration of FIG. 4, a physician 4 or user 1 can set up his or her preferences via a preferences module 400. In such a configuration, the physician 4 may be presented with an option to log into the preference module 400 (part of the software platform) using an account logger 401A. The account logger 401A may inform the software platform 10 of which physician preferences to set, as well as restrict access to modifying those preferences to a user 1 who has access to a specific credential (e.g. a password or token). The preferences module 400 may present the user 1 with a preference viewer 402 which may allow the user to select an anatomy group in which to set preferences. The anatomy group selector 401′ may be embodied as a radial tool, empty, dropdown box, or other software method or tool which allows a physician to specify the anatomy group (hip, shoulder etc) in which he or she is saving preferences. To set hip preferences for example, button 401 may be selected. Then the activity level may be selected via the option setter 404, which sends the set information to the preference editor.

Since the activity level of the patient 7 may affect the physician's choice for implant hardware, the preferences module 400 may allow the physician to set an activity level for the patient 7. Patient's having a high activity level may receive stronger or lighter implant hardware, while more sedentary patients may receive heavier or weaker hardware. The cost for the implant hardware for more sedentary patients may be lower as a result. In FIG. 4, a user can select a desired activity level 405 via a drop-down box 407, but other selection options could be used. In addition to activity level, the preferences module may allow the user to specify what type of procedure 406 is being performed. In the example in FIG. 4, a total hip replacement is specified. Examples of other procedures include total knee replacements, total shoulder replacements, Implantable defibrillators, and or stents. The option setter 402 may also be used to set other factors such as age, ASA (a measurement of activity level), and BMI (or height and weight) or preference level, but in the embodiment shown in FIG. 4, the preference level 462 is set in the preference viewer 402 and the other factors (411, 414, and 417) are set in the preference editor 410. Indeed, certain embodiments may combine the option setter 402 into the preference viewer 402 or preference editor 410. In some embodiments, preferences set in one window may be altered in another module, such as procedure type 406 and procedure 423. This configuration may be useful in the event case the physician changes his or her mind as to what type of procedure he or she wishes to set preferences for.

In one embodiment of the present invention, each procedure type 406, may have a line of products the physician can select from. The physician can select one or more of these products using the equipment selector 420′. Although shown as using labels and dropdown boxes, an equipment selector 420′ can embodied through alternate techniques such auto-filling text or radial boxes. Once selected, via the dropdown box 424, the preference editor 410 can present the physician 4 with various system clusters 425 of equipment to choose from. For example, the physician 4 may choose the make and model of the implant itself, which disposables will be needed (cement gum, sutures, etc), and which instrumentation (implant specific instruments, X-ray, etc) will be required. These equipment choices may be selected via the system and class dropdown boxes 422 and 428. The list of options in the dropdown box 422 may be filtered by the specified procedure 423 and associated dropdown box 424.

The example shown in FIG. 4, shows the physician 4 selecting a Articul/eze™ a component of the Summit brand hip replacement technology. Filed along with the present invention is a copy of Depuy Orthopaedics Articul/eze hip replacement brochure published 2001, the contents of which are incorporated herein in its entirety. Other hip replacement systems may 120 also be presented to the user in the drop-down box 426. In FIG. 4, the user has selected an Articul/eze™ Head as the particular class of implant to specify additional information.

Some classes of implants may have different structural design features such as how the implant was sterilized, what size it is, how it was constructed, how strong is the implant and what ranges of motion does it have, its geometry and weight, and whether it utilizes pores as a growth fixation mechanism or cementing as the fixation mechanism. For example, in the detail window 430, the physician may be presented with a series of sizes 431, 432, and 433 for the implant and may also be provided with a graphic representation 434 of the implant. Size may affect strength, performance, and cost of the implant. In the embodiment shown in FIG. 4, three sizes for the Articul/eze™ head are provided, but many other sizes could be presented. A physician may select a particular size head by double-clicking on the graphic. Performing the selection command adds the implant and associated structural design features to the saved items window 440. (Alternate embodiments may use a drag-and-drop feature for example.) The physician 4 may also specify a backup implant preferences, should the procedure call for different or more complex implants by clicking on the backup tab or second choice option 442. Clicking on the tab 441 allows the user to return to setting preferred implant hardware for preference A. The embodiment shown in FIG. 4 also allows the user to specify his or her second preferred size implant by clicking on the preference B tab 443. Backup tab 444 can similarly store backup sizes for implants that are unavailable or out of stock. The saved items window 440 may contain a symbol field for showing a graphic representation of the surgical item, and system field for providing a written description of the surgical item.

In the embodiment shown in FIG. 4, the physician can select different manufacturer lines or system clusters for a particular surgery (i.e. a mix-and-match option.) In some configurations, a physician 4 can select a different system of implants to combine with the first system of implants. For example in FIG. 4, the user added a Cancellous™ Screw 6.5 mM and a Pinnacle Altrx™ Liner 28 MM by using a system and class. Thus in the preference A tab, the user has selected an Articul/eze™ Head 22 MM, a Cancellous™ Screw 6.5 mM, and a Pinnacle Altrx™ Linear 28 mM for a total hip replacement in the age range of 40-50, ASA range of P2-P3, and a BMI range of normal. Once all of these options are set by user, he or she can submit them to the software platform by clicking on the submit button 445.

In addition to selecting the particular equipment the physician 4 can set certain factors to associate the equipment with a certain type of patient. Factors such as age 411, ASA 414, and BMI 417 may be offered, but other factors such as height & weight, surgical technique such as invasiveness or angle of implantation, co-morbidity factor or health descriptors may be included. In the embodiment shown in FIG. 4, the user 1 can specify the ranges for these characteristics by adjusting age slider 412, ASA slider 415, and/or BMI range slider 418. Once set, the interface may display the value set in the slides in the age display panel 413, ASA display panel 416, or BMI display panel 419. In alternate embodiments, different sliders and corresponding display panels may be featured.

Clicking on the submit button 445 or otherwise saving the information may cause the preference module 400 to store the information in a database 20 directly or through the software platform 10. Clicking on the submit button 445 may also cause the preference module to display the preference viewer 402 again. Once some preferences have been stored in the database, the physician may be able to view the stored preferences via viewer, table 450, or chart. The table in FIG. 4 has three rows 451, 452, 453 but additional rows may be added as new preferences are saved. Since a user 1 may add a large number of rows to the table 450, it may be difficult for the user to locate a particular row of interest. To facilitate locating a row of interest, a search function 460 may be added to the preference module 402. Alternatively or in addition, preference module 402 may contain one or more filters 462 and 463. Preference level filter 461 may allow the user to filter by preference level. The preference level filter may be embodied as a drop-down box having options such as high, medium, low, and all. FIG. 4 illustrates the user has selected “All” as the preference level. Procedure type filter 462 may allow the user to filter by procedure type. FIG. 4 illustrates the user has selected “Total Hip” as the procedure type. As a result of these selections, all preference levels are displayed and only procedure types “Total Hip” are displayed in the table 450.

Table 450 can be used to view various preferences (pre-established or previously stored) by the physician 4, including categories such as: group, procedure type, preference level, age range, ASA range, BMI range, and/or benchmark. Group refers to the general area an operation may be performed on, such as a hip, shoulder, hand, etc. Procedure type refers to the type operation that may be performed, such as partial hip replacement, total hip replacement. Preference level refers to the user's desire to perform the surgery on a particular patient provided the patient's procedure type, ASA range, age range, and BMI range. Age range is a range of ages specified by the user. ASA range is a measurement of a person's ability to heal from a particular procedure. BMI range is a range of body mass indices. Benchmark is a measurement of physicians who have chosen a particular implant for a particular procedure and patient type. As shown in the embodiment of FIG. 4, the BMI range displays words such as normal or overweight, and the age displays numerical ranges. However, age ranges could include words such as teen, twenties, etc, or BMI could utilize numerical indices. Similarly, the preference level could be numerical as well.

Through storing a physician's preferences in the database 20, certain users of the software platform may be provided access to see what equipment (e.g. implant, instrumentation, disposables) a physician uses for what surgeries. Through establishing a relationship between the type of equipment and the patient type (what surgery, activity level, age, BMI, etc.) a nurse or other medical personnel can use a scheduling module 200 to submit a booking request to operating staff, order the equipment from the manufacturer, reserve hospital owned equipment, and send instructions to the patient without necessarily needing a physician's assistance.

### The Scheduling Module 200

The scheduling module 200 allows a nurse 2 or other user 1 to schedule or view a surgery for a patient. In some embodiment a nurse may enter the name of the physician 4 performing the surgery, the surgery to be performed (hip, knee, etc), one or more patient factors (e.g. age, ASA, BMI), and/or the patient activity level. To schedule or view a procedure, the nurse could log into the scheduling module 200 (which may be part of the software platform) using an account logger similar to that account logger 401A of the preferences module 400. Once logged in, the nurse may be presented a procedure calendar 210. Clicking on one of the anatomy icons 230, causes the scheduling module to display the new procedure window 250.

The procedure calendar 210 may contain a status indicator 223, time field 224, physician field, patient field, anatomy field, procedure field, operative side field, hospital information field, scanned items field, and a trash icon. To view or set up a schedule for a particular physician, the nurse 2 may select the physician from the physician dropdown box 220. The date viewer 221, allows the user to select one or more days to view in the procedure calendar 210. A status filter 222 allows the user to filter various statuses such as all, preparing requirements (indicating that the manufacturer's sale representative has accepted the procedure and is processing the order for the equipment), ready (the hospital has the equipment available for the surgery), saved, not completed (the procedure has been partially entered, but needs to be completed before the software platform sends it to the manufacturer to be filled), submitted (the order for equipment has been submitted to the sales representative but not yet accepted), and completed (the procedure has been completed). In some embodiments, a status indicator 223 can be provided to provide rapid identification of a procedure's status. For example in one embodiment, preparing requirements may be solid red, ready may be solid green or blue, saved, not submitted may be solid yellow, submitted may be flashing red, and completed may be solid gray with green arrows. The time field 224 may allow a user to sort by time for example. Clicking on another column may allow the user to sort by that column. Clicking on the trash icon 225 may allow the user to delete the procedure. Deleting a procedure may send information to the software platform 10 to distribute the cancellation of the procedure to the patient, physician, hospital, distributor, and manufacturer. To view procedures which have been cancelled, the user may click on the cancelled items icon 225′.

If the nurse or user wants to add a new procedure, the user can click on one of the anatomy group icons (knee, hip, shoulder, arm/leg, or foot/hand) to begin setting up a new procedure. In other embodiments, the scheduling module 200 may have a new procedures button. When a new procedure is selected; the scheduling module 200 will generate a new procedure window 250.

The new procedure window 250 allows a nurse or other user to book a new procedure. The patient information field 260 requests information such as patient name, email, SSN, chart, DOB, allergies, occupation, race, and gender. Under the procedure information field 270, the nurse can enter the hospital from a list of hospitals, billing information, and the date and time of the procedure. The procedure type field 280 allows the nurse to select which procedure is going to be performed (for example, total primary knee, unicondylar knee, revision knee, dual compartment knee, HTO, or pattelo femoral replacement.) The procedure type field 280 also allows the nurse to select the operative side (left, bilateral, or right.) To save the procedure the nurse can click a submission function such as save and close to save and make the procedure visible to the manufacturer, or save and next to enter another procedure. Cancel, cancels the procedure entry process.

### The Manufacturer Module 300 and Warehouse Module 500

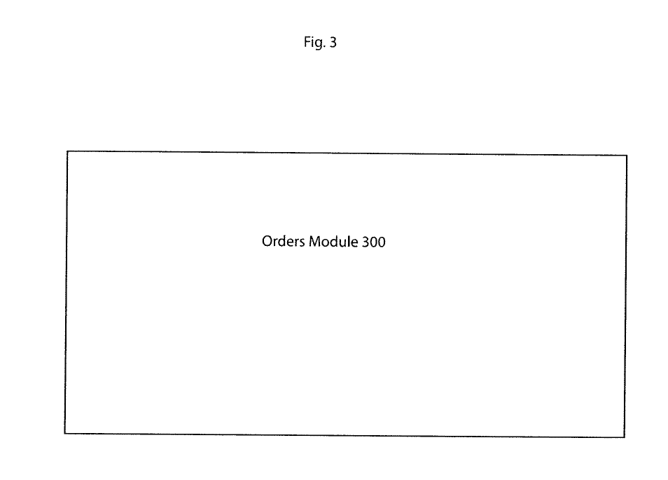

Once the procedure is saved, the software platform 10 can make the procedure visible to the manufacturer 3. The manufacturer 3 may be able to access the visible procedures through an orders module 300 (FIG. 3). The manufacturer 3 may determine that the hospital at which the surgery is being performed has sufficient consignment equipment to complete the procedure. In that case, the manufacturer 3 may mark the status of the procedure blue. Consignment equipment may be equipment owned by the manufacturer which is stored at the hospital 6 and purchased from the manufacturer 3 when the procedure is performed.

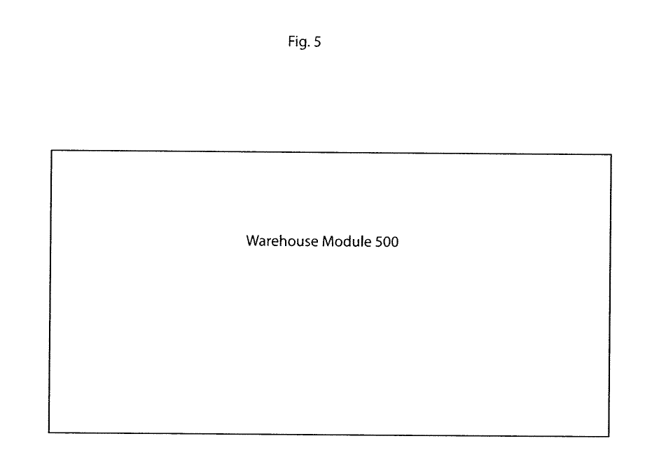

If the manufacturer 3 determines that there is insufficient consignment equipment at the hospital 6, the manufacturer 3 may mark the status indicator 223 with a flashing red icon. The manufacturer 3 may contact its warehouse or distributor 5 to distribute the needed equipment directly, or (as shown in FIG. 1) the manufacturer 3 may use the software platform 10 to send a request to the warehouse 5. In some embodiments, marking the procedure with a flashing red icon (or otherwise indicating that additional equipment is needed), automatically sends a request through the software platform 10 to inform the warehouse that the additional inventor is needed. The warehouse or distributor 5 can utilize a warehouse module 500 (FIG. 5) to view the order, and begin fulfilling it. In some embodiments the warehouse 5 may use the warehouse module 500 to mark the procedure solid red when it is received, but not yet filled, yellow when it is partially filled, and green when the order is fulfilled and shipped to the hospital.

The orders module 300 may also contain a recall module 350 or the recall module 350 may be a separate module. The recall module 350 may allow a manufacturer to send an alert through the software platform 10 that a particular implant should be recalled, is unsafe, has some newly discovered side effects, etc. Once the manufacturer 3 sends the alert to the software platform 10, the software platform 10 could query its database to determine which patients 7 have the implant, which physicians 4 installed the implants, and which hospitals provided the equipment for the procedure. Physicians 4, nurses 2, and hospitals can also be warned not to use a particular implant. In some embodiments, these warning could be sent in real time, potentially preventing unsafe procedures. In some embodiments a patient 7 may be warned directly through a patent module 700.

### The Patient Module 700

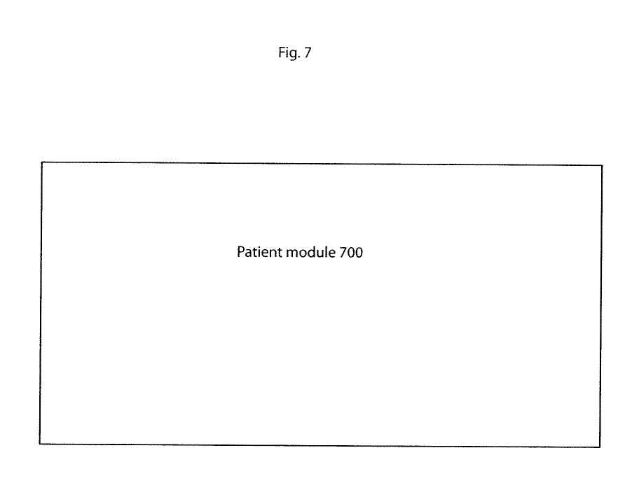

The patient may be provided with a patient module 700 (FIG. 7) to view information about an upcoming or past procedure. The patient module may provide information about the patient, the procedure, the implant, rescheduling information, physician and hospital information, etc. In some embodiments, the patient module 700 can warn a patient 7 about a procedure that may be potentially dangerous. Medical advice, directions, and physician/patient correspondence may also be provided through the patient module 700.

### The Hospital Module 600

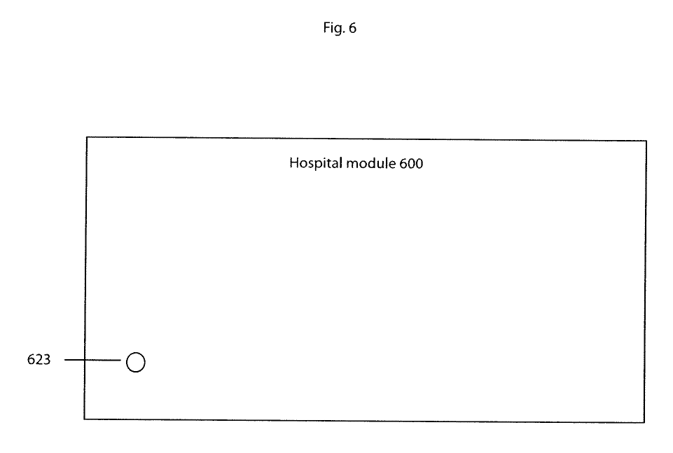

Before the surgery (usually the day before or morning of the surgery), a medical staff person (such as a nurse or orderly) can use the software platform 10 to verify that all the medical equipment is present in the hospital. To perform this verification the nurse 2 may log into the scheduling module 200 and look at the status indicators for the procedure. In alternate embodiments, a hospital module 600 (FIG. 6) may be provided to allow hospital staff to access the software platform 10. In one embodiment, the hospital module 600 may have status indicators 623 which might show a green light if loaned equipment is present in the hospital. In order to improve distribution of equipment to hospitals, representatives of the manufacturer 3 or warehouse 5 may shuttle equipment between hospitals. For example, hospital A may perform hip replacements on Mondays and hospital B may perform hip placements on Wednesdays. To meet the demand spikes that may occur at the hospitals the manufacturer 3 or warehouse 5 may shuttle equipment to these hospitals. This equipment would be called loaner equipment, and in some embodiments be identified with a green status indicator.

Hospitals may also purchase their own equipment for use in surgeries. If the hospital owns the needed equipment, the status light 623 may be blue. Alternatively, if the equipment is stocked in the hospital as consignment inventory (purchased from the manufacturer 3 or warehouse 5 when it is used for the procedure), the hospital module 600 may utilize a blue light to indicate the equipment is consignment equipment.

The medical staff person (such as a nurse's aid or orderly) can use the hospital module to generate a patient ID card. This ID card is linked to the procedure being performed. The card itself may be an RFID token, barcode label, or magnetic strip card, and the hospital module 600 may program the card through a card programmer (a machine that stores information on the card.) Once the card is programmed, the medical staff person could enter a controlled storage facility to obtain the needed equipment.

In one embodiment, the storage facility would contain a locked entrance which can be opened by scanning the ID card at a nearby control module 650. The control module 650 may contain a touch screen and a card reader for example. Inside or near the storage facility, the control module could be used to inform the medical staff person which equipment is needed for the surgery. For example, scanning the card at the control module 650, may cause the module 650 to send a request for information from the software platform 10. The software platform 10 may look up the requested information about the procedure associated with the patient ID in the database 20. Once the data is received the software platform 10 may return a list of items to the control module 650. The hospital staff person 6 could gather the items from a storage room and take them to the operating room to prepare for the surgery. In some embodiments, the controlled storage facility may automatically secure all equipment other than the equipment which is on the list in the control module 650. Other embodiments may utilize a guard who might verify that only the needed items are being taken from the storage facility.

At the operating room, the hospital staff person 6 may scan the patient ID card and scan the equipment right before they are used for the surgery (i.e. at the point of care). The scanning may take place at the hospital module 600. By scanning the equipment and associating the equipment with the ID card, the patient 7 can have ready access to what equipment was used in the surgery, what type of implant was used, etc. The patient 7 may be able to use the ID card and/or the patient module 700 to access this information. The hospital staff person 6 could use the hospital module 600 for example to scan this information. The hospital module may also allow the hospital staff person 6 or the physician 4 to enter notes about the surgery to inform future physicians 4 about details of the procedure such as possible reactions.

### The Analysis Module 100

The software platform 10 may have an analysis module 100 to analyze patterns based on information stored in the database 20 of the platform 10. This may be useful for determining clinical data such as how implants were used for what types of procedures, which implants physicians prefer, contrasting regional differences in equipment selection, etc. Using the analysis module 100 a hospital could monitor or analyze which physicians are ordering what equipment for which types of surgery. The hospital could use the module 100 to determine how much money a physician spends on equipment in relation to money he or she generates in patient procedures. Hospitals could compare these costs against other physicians or compare a particular physician's profitability against similarly positioned physicians. Manufacturers 3 could use the module 100 to learn which equipment is being ordered for what procedures. Physicians 4 can compare what decisions other physicians are making for procedures vis-à-vis to gain insight on how to make better equipment choices. These comparisons may also be made against regional or national averages. Users 1 of the software platform 10 can analyze benefits of using one type of implant versus another, which implants have been more effective for what types of procedures, which manufacturer develops longer lasting equipment or equipment with less installation complications, etc.

Another benefit of the software platform 10 is the platform allows a patient 7 to have his or her procedure history updated if he or she returns to the hospital. A medical staff person could update information relating to rejection of an implant, healing of incisions, secondary infections, etc. Users of the module 100 may review patient thoughts about the implant and describe pain and/or benefits of using the implants.

The module 100 may also be used to determine whether there are any implants or procedures, that require frequent revisions (removals, corrections, follow-up visits, etc). From this information, the module 100 itself or a person utilizing the module 100 could determine that a particular implant or piece of equipment is unsafe. Such a determination may be aided by comparing the procedure to results obtained for patients having a similar diagnosis that were treated with different equipment.

1. Software stored on computer readable media for causing one or more computers to execute the software thereby generating a preferences module in memory of the one or more computers; said preferences module comprising:
a. an anatomy group selector for allowing a user to select an anatomy group in which a procedure could be performed on a patient;
b. age, activity level, and height and weight selectors for allowing the user to store age, activity, and height and weight information about the patient; and
c. an equipment selector for selecting a first implant to use with the exemplary patient based upon the patient's activity level, age, and height and weight.

2. The preferences module of claim 1 wherein the equipment selector allows the user to select certain associated structural design features about the implant which are selected for the particular age, activity level, and height and weight of the patient.

3. The preferences module of claim 1 wherein the activity level is defined by ASA or UCLA scores.

4. The preferences module of claim 1 wherein the height and weight are expressed as a patient's BMI.

5. The preferences module of claim 1 comprising: a second choice option for allowing the user to specify a second implant for use with the procedure if the first implant is not available.

6. The preferences module of claim 1 wherein the equipment selector contains manufacturer, product line, system cluster, and size selection options.

7. The preferences module of claim 1 wherein the equipment selector allows the user to select a type of implant, disposable, and instrumentation to use with the procedure.

8. The preferences module of claim 1 comprising a submission protocol for sending information entered in the preferences module to a software platform comprising a database.

9. The preferences module of claim 1 comprising: a preferences viewer for storing previously saved preferences for one or more selected anatomy groups.

10. Software stored on computer readable media for causing one or more computers to execute the software thereby generating a scheduling module in memory of the one or more computers; said scheduling module comprising:
a. a procedure calendar for allowing a user to view information pertaining to a previously scheduled procedure; said information including a status indicator; and a physician field; patient field; and anatomy field;
b. a new procedure window for booking a new procedure requiring medical equipment;
said procedure window comprising:
i. a patient information field;
ii. a procedure information field;
iii. a procedure type field;
c. a submission function for saving information entered in the new procedure window; wherein the submission function sends a request to a manufacturer provide the medical equipment to a specified hospital in which the procedure is selected to be performed.

11. The scheduling module of claim 10 wherein the status indicator contains status types including a preparing requirements status; a ready status; saved, not completed status; a submitted status; and a completed status.

12. The status indicator of claim 11 wherein the status indicator is programmed to display a different color status indication for each status type.

13. Software stored on computer readable media for causing one or more computers to execute the software thereby generating a software platform comprising a preferences module and a scheduling module in memory of the one or more computers;
a. said preferences module comprising:
i. an anatomy group selector for allowing a first user to select an anatomy group in which a procedure could be performed on a patient;
ii. age, activity level, and height and weight selectors for allowing the first user to store age, activity, and height and weight information about the patient; and
iii. an equipment selector for selecting a first implant to use with the exemplary patient based upon the patient's activity level, age and height and weight.
b. said scheduling module comprising:
i. a procedure calendar for allowing a second user to view information pertaining to a previously scheduled procedure; said information including a status indicator; and a physician field; patient field; and anatomy field;
ii. a new procedure window for booking a new procedure requiring medical equipment; said procedure window comprising:
1. a patient information field;
2. a procedure information field;
3. a procedure type field;
iii. a submission function for saving information entered in the new procedure window; wherein the submission function sends a request to a manufacturer provide the medical equipment to a specified hospital in which the procedure is selected to be performed;
c. wherein the second user may book a procedure knowing only the first user's identity, anatomy group of the procedure, age, activity level, and height and weight of the patient.

14. The preferences module of claim 13 wherein the equipment selector allows the user to select certain associated structural design features about the implant which are selected for the particular age, activity level, and height and weight of the patient.

15. The preferences module of claim 13 wherein the activity level is defined by ASA or UCLA scores.

16. The preferences module of claim 13 wherein the height and weight are expressed as a patient's BMI.
